(19) United States
(12) Patent Application Publication
(10) Pub. No.: US 2012/0279806 A1
(43) Pub. Date: Nov. 8, 2012

(54) OBSTRUCTION MONITORING METHOD AND SYSTEM FOR A VERTICAL RECIPROCATING CONVEYOR

(75) Inventor: Mark Webster, Hubertus, WI (US)

(73) Assignee: PFLOW INDUSTRIES, INC., Milwaukee, WI (US)

(21) Appl. No.: 13/464,373

(22) Filed: May 4, 2012

Related U.S. Application Data
(60) Provisional application No. 61/482,656, filed on May 5, 2011.

(51) Int. Cl. B66B 5/02

(52) U.S. Cl. 187/289

(57) ABSTRACT

A method and system for controlling the operation of a drive motor for a vertical reciprocating conveyor. The method initially activates a drive motor to move a carriage from a resting position. After initial start-up period, the method sets a threshold current value as the present current value being drawn by the drive motor. The method compares subsequent present current value measurements to the threshold current value and determines whether the present current value exceeds or falls below the threshold current value by more than an operating limit. If the present current value falls within the operating limits, the threshold current value is updated to the present current value on a periodic basis. In this manner, the method continuously updates the threshold current value to compensate for an increase in the weight being lifted by the vertical reciprocating conveyor.

### CROSS-REFERENCE TO RELATED APPLICATION

The present application is based on and claims priority to U.S. Provisional Patent Application Ser. No. 61/482,656 filed May 5, 2011, the disclosure of which is incorporated herein by reference.

### BACKGROUND OF THE INVENTION

The present disclosure relates to a method and system for controlling the operation of a vertical reciprocating conveyor. More specifically, the present disclosure relates to a method and system for controlling the operation of a vertical reciprocating conveyor to terminate operation of the conveyor upon a sudden change in the operating state to the drive mechanism for the vertical reciprocating conveyor.

Presently, vertical reciprocating conveyors (VRC) are used to move large payloads between different levels in a warehouse or other similar facility. The vertical reciprocating conveyor includes a carriage that moves along a series of spaced vertical supports. In some embodiments, the carriage is moved between different floors by operation of an electric drive motor. The operation of the electric drive motor moves a lifting chain that is connected to the movable carriage. As the drive motor rotates, the lifting chain lifts or lowers the carriage along the spaced vertical supports.

During normal operation of the vertical reciprocating conveyor, the drive motor draws a supply of current from a power supply. During normal operating conditions, the amount of current drawn from the power supply is below a maximum overload value which is based upon the maximum rated weight for the vertical reciprocating conveyor. However, if the moving carriage becomes jammed or impaired in some manner, the motor will draw additional current or power in an attempt to provide additional torque to move the carriage. When the amount of operating current drawn by the motor exceeds the maximum overload value for the conveyor, an overload circuit associated with the conveyor will prevent further operation of the drive motor. Although present conveyor assemblies include an overload protection circuit, such circuits only detect the current corresponding to the maximum rated load capacity of the machine. The additional torque provided by the drive motor can last for a period of time before the overload circuit trips. During this time, the drive motor may exert the additional torque on the carriage, which can result in damage to the conveyor or the article causing the jammed condition.

When a typical VRC encounters an obstacle when the carriage is moving in the downward direction, the drive motor continues to operate unless the carriage is stopped by and supported by the obstacle. When this occurs, the drive motor continues to feed the lifting chain down toward the carriage until a slack chain sensor trips, thereby shutting down the drive motor. At this point, the obstacle causing the jam is supporting the entire weight of the carriage as well as any payload present on the carriage.

During operation of the VRC, the weight of the lifting chain that is being lifted by the drive motor varies depending upon the vertical position of the carriage. In some embodiments, this weight can be significant. As an example, on a four post lift that utilizes four #140 pitch roller chains, the lifted weight changes by approximately 50 pounds for every 15 inches of vertical movement of the platform. Thus, the amount of current drawn by the drive motor changes significantly for a constant weight being lifted over the vertical run of the conveyor assembly. Thus, the amount of current drawn by the drive motor changes during the movement of the carriage due to the changing weight of the lifting chain.

Although an electric drive motor is often used to move the carriage in a VRC, other types of conveyors use hydraulic power to move the carriage of the VTC. A hydraulically powered VRC can include lifting chains that change the weight being lifted by the hydraulic operating cylinders in the same manner as described above.

### SUMMARY OF THE INVENTION

The present disclosure generally relates to a method and system for controlling the operation of a vertical reciprocating conveyor. More specifically, the present disclosure relates to a method and system that monitors and controls the drive mechanism of a vertical reciprocating conveyor to terminate movement of the carriage of the vertical reciprocating conveyor upon a sudden or unexpected change in the operating state of the drive mechanism of the vertical reciprocating conveyor.

The vertical reciprocating conveyor of one embodiment of the present disclosure includes a drive motor that is operable to move a carriage between multiple different levels. During operation of the drive motor, the drive motor draws current from a power supply. The amount of current drawn from the power supply depends upon the amount of weight on the carriage and thus the load on the drive motor. In an embodiment in which the carriage is lifted by lifting chains, the load on the drive motor varies depending upon the amount of lifting chain being lifted by the drive motor along with the carriage. Thus, during normal operating conditions, the load on the motor varies depending upon the height of the conveyor.

In one embodiment of the disclosure, the disclosure provides a method of controlling the operation of the vertical reciprocating conveyor by initially operating the drive motor to move the carriage from a resting location. As the carriage moves from the resting location, the amount of current drawn by the motor to initially move the carriage from the resting location is sensed.

After an initial start-up period, the method defines a threshold current value that is based upon the sensed amount of current drawn by the drive motor during the initial movement of the carriage. The threshold current value is stored in a memory location within a controller of the vertical reciprocating conveyor. After the initial start-up period, the method compares the present value of current being drawn by the drive motor to the threshold current value. If the present value of current being drawn by the drive motor exceeds or falls below the threshold current value by more than an operating limit, the method stops operation of the drive motor to terminate movement of the carriage. Thus, if the carriage contacts an obstacle or obstruction when moving either upward or downward, the present value of the current drawn by the drive motor will vary from the threshold current value by more than the operating limit. Thus, the method terminates operation of the drive motor upon the carriage contacting an obstacle or obstruction in either the upward or downward movement direction.

If the present value of the current drawn by the drive motor does not exceed the threshold current value, the method updates the threshold current value to be the present current value. Thus, the method continuously updates the threshold current value, which compensates for the changing amount of the lifting chain being moved by the drive motor. Thus, unlike prior control systems, the method of the present disclosure compensates for the changing load on the drive motor as the carriage moves to different vertical positions.

In one embodiment of the disclosure, the operating limit is a percentage of the threshold current value. In this manner, the method stops operation of the drive motor when the present current value varies from the threshold current value by more than a predetermined percentage of the threshold current value. In one embodiment of the disclosure, the present value of the current is an average of multiple current measurements taken over a measurement period. As an illustrative example, the system and method can make multiple current measurements each second and average the multiple present current measurements to develop the present current value.

In addition to a method that monitors current drawn by a drive motor, the present disclosure also contemplates a method that monitors another type of drive mechanism, namely a hydraulic fluid pump. In this alternate embodiment, the pressure of hydraulic fluid supplied by a hydraulic pump is monitored. The method of the alternate embodiment compares the present pressure of the hydraulic fluid to a threshold pressure value and terminates operation of the hydraulic pump if the present pressure value exceeds or falls below the threshold pressure value by more than an operating limit. The threshold value is updated during operation of the VRC, which compensates for the changing amount of the lifting chains being moved by the hydraulic pump through the hydraulic lifting cylinders.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a schematic representation of a vertical reciprocating conveyor including the control system of the present disclosure;

FIG. 2 is a schematic representation of the control system used with the vertical reciprocating conveyor;

FIG. 3 is a flowchart illustrating one method of controlling the operation of the vertical reciprocating conveyor;

FIG. 4 is a schematic representation of the control system used with a hydraulically powered vertical reciprocating conveyor; and

FIG. 5 is a flowchart illustrating another method of controlling the operation of a hydraulically powered vertical reciprocating conveyor.

### DETAILED DESCRIPTION OF THE INVENTION

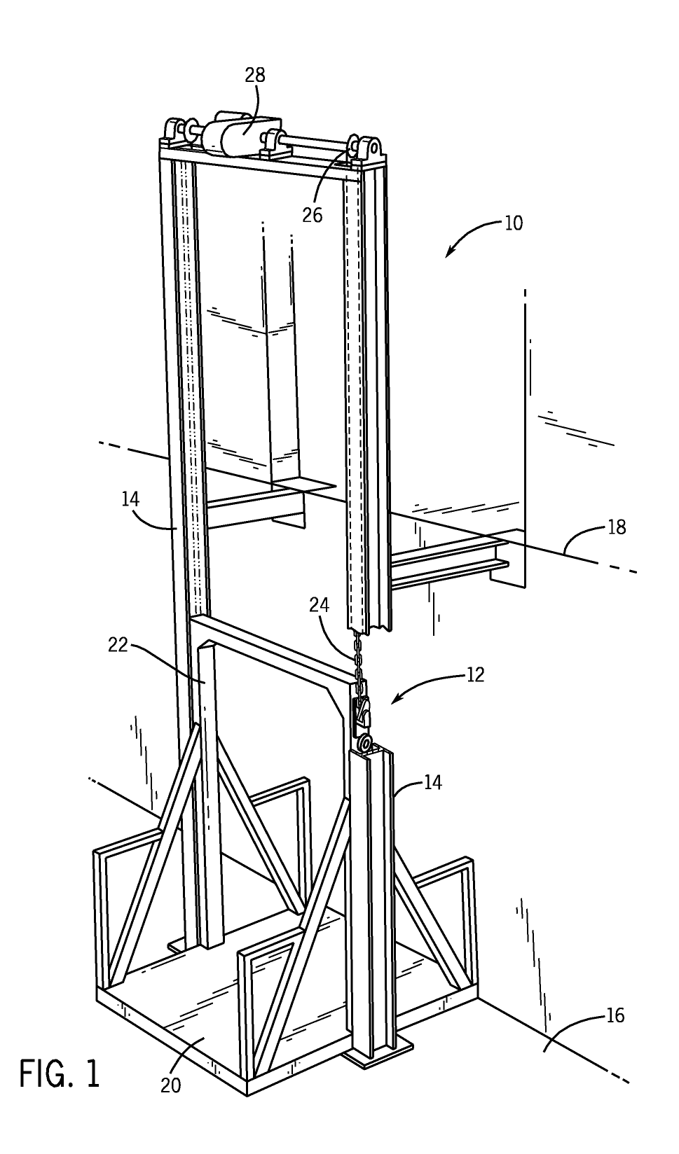

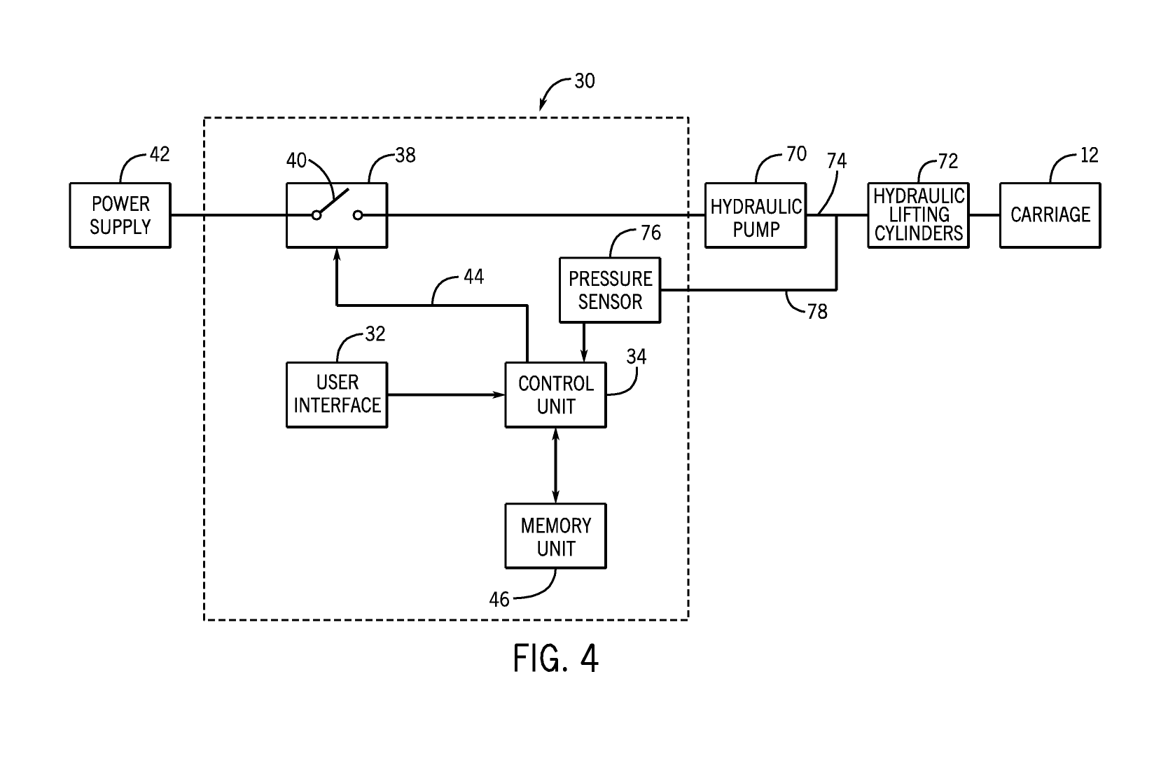

FIG. 1 illustrates a vertical reciprocating conveyor 10 that forms part of the present disclosure. The vertical reciprocating conveyor 10 includes a carriage 12 that is movable along a pair of spaced support rails 14. The support rails 14, in the embodiment shown in FIG. 1, extend between a ground floor 16 and a first floor 18. Although only the ground floor 16 and the first floor 18 are shown in the embodiment of FIG. 1, it should be understood that the vertical support rails 14 could extend between additional floors. Additionally, although only a pair of spaced support rails 14 is shown in the embodiment of FIG. 4, it should be understood that the vertical reciprocating conveyor 10 could be an embodiment in which four or more separate support rails create a self-supporting structure for guiding and supporting the movement of the carriage 12.

The carriage 12 includes a support platform 20 that is mounted to a carriage frame 22. The carriage frame 22 is connected to a lifting chain 24 at each of its spaced sides. The lifting chain 24 passes along an inside edge of the support rail 14 and passes over a drive sprocket 26. The rotation of the drive sprocket 26 is controlled by a drive motor 28.

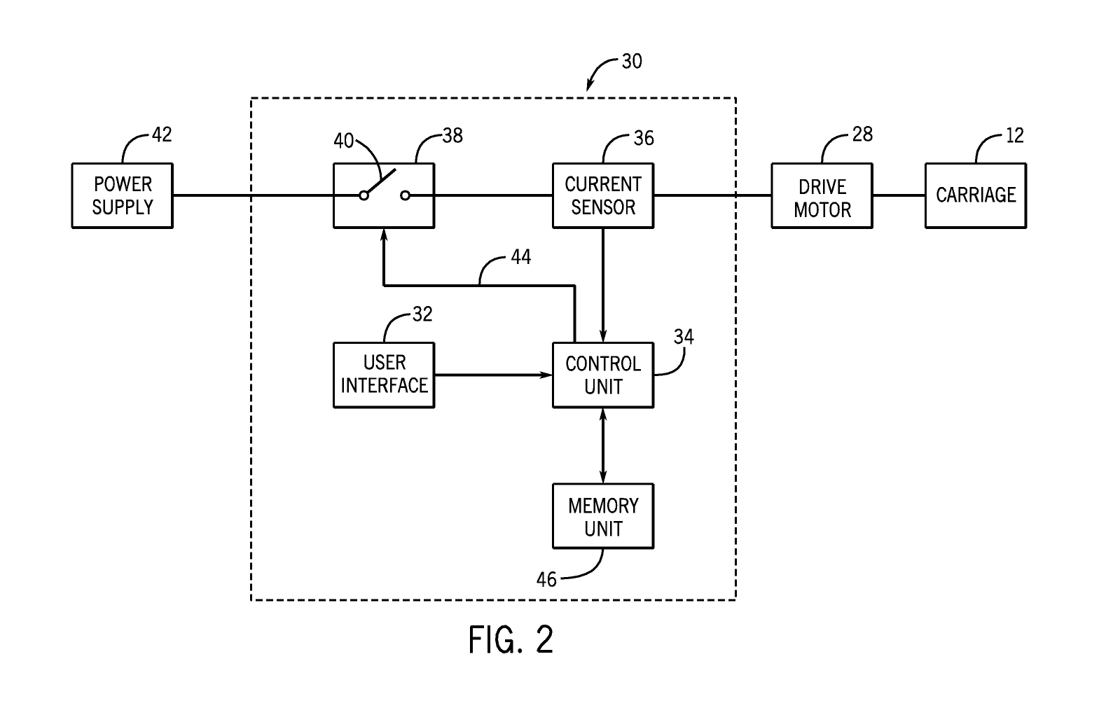

In the embodiment of the disclosure illustrated in FIG. 1, the drive motor 28 is a three-phase induction motor. However, the disclosure is not limited to a three-phase induction motor. Instead, the disclosure can be used with almost any electric motor that has a relationship between the current drawn by the motor 28 and the torque generated by the drive motor 28. Other example motor types include, but are not limited to, single-phase induction motors, synchronous motors, direct current motors, etc. As is commonly known, the drive motor 28 receives electric power and produces mechanical power in response to the application of electric power. The mechanical power provided by the drive motor 28 rotates the drive sprockets 26 and causes the lifting chain 24 to move the carriage 12 both upward and downward depending upon the initial position of the carriage 12 and the direction of motor rotation. The operation of the drive motor 28 is controlled by a conveyor controller 30 shown in FIG. 2.

As shown in FIG. 2, the conveyor controller 30 includes a user interface 32 that allows an operator to enter operational parameters into a control unit 34. It is contemplated that the user interface 32 could be any type of device that allows the user to enter input parameters into the control unit 34, such as a switch, a series of switches, a keyboard, touchpad or any similar device.

In addition to the user interface 32, a current sensor 36 is operatively connected to the control unit 34. The current sensor 36 senses the amount of current drawn by the drive motor 28 when the contactor 38 is in the closed position. In the embodiment shown in FIG. 2, the contactor 38 is represented by a single switch 40 positioned between the power supply 42 and the drive motor 28. Although a single switch 40 is shown as part of the contactor 38, it should be understood that the contactor 38 could include three switches when the drive motor is a three-phase motor. The contactor 38 is connected to the control unit 32 through a control line 44 such that the control unit 34 can interrupt the operation of the drive motor 28 by opening the switch of the contactor 38. Likewise, the control unit 34 can allow operation of the drive motor 28 by closing the switch of the contactor 38.

In the embodiment shown in FIG. 2, the current sensor 36 can be any type of current sensor that is able to provide an accurate, real-time current measurement to the control unit 34. As will be described in greater detail below, the control unit 34 monitors the amount of current drawn by the drive motor in real-time such that the control unit 34 can discontinue operation of the drive motor 28 upon an over-current or under-current condition that may be a result of an obstruction to the movable carriage 12.

Although a current sensor 36 is shown in the embodiment of FIG. 2, it should be understood that the current sensor 36 could be replaced by other sensors that will allow the control unit 34 to monitor the operation of the drive motor 28. As an example, the current sensor 36 could be replaced by a voltage sensor or a torque sensor to monitor the operation of the drive motor 28.

In the embodiment shown in FIG. 2, the control unit 34 is further connected to a memory unit 46. The memory unit 46 can include multiple memory devices and include both program storage memory and data storage memory. The control unit 34 retrieves information from the memory unit 46 and stores information to the memory unit 46 as desired.

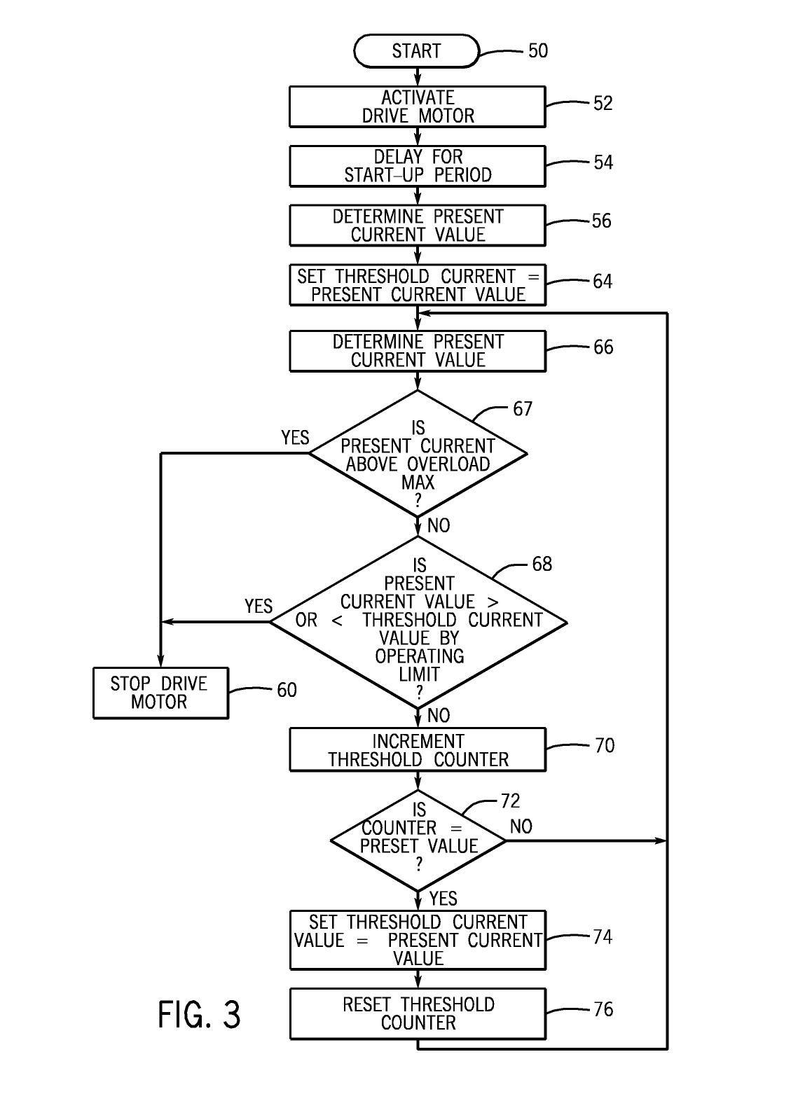

FIG. 3 includes a flowchart that further illustrates the overload detection process of the present disclosure. The flowchart shown in FIG. 3 can be carried out through operation of the control unit 34 in connection with the memory 46.

As illustrated in FIGS. 2 and 3, the control unit initially receives an input from the user interface indicating that a request to start the drive motor has been received, as indicated by step 50. The request to start the operation of the drive motor could be received from an input device such as a series of operating buttons positioned on a control panel for the conveyor 10.

In response to receiving the request to start operation of the drive motor, the control unit closes the switch 40 in the contactor 38. When the switch 40 is closed, power is supplied to the drive motor 28 through the current sensor.

Referring back to FIG. 3, once the drive motor has been activated, the control unit delays for a start-up period in step 54. The start-up period allows the drive motor 28 to begin operation before the control unit begins to monitor the current drawn by the drive motor.

In step 56, the control unit obtains a signal from the current sensor 36 to determine the present current value being drawn by the drive motor 28. As described previously, the current sensor 36 provides a signal to the control unit 34 such that the control unit 34 can determine the current draw by the drive motor at any instant in time.

Once the control unit determines in step 54 that the start-up period has expired, the control unit determines that the initial start-up phase has passed and the control unit proceed to step 64. In one example of the disclosure, the start-up period in step 54 is approximately two seconds. However, the value for the start-up period can be adjusted through the user interface 32.

When the control unit proceeds to step 64, the control unit sets a threshold current value to be the present current value being drawn by the drive motor immediately following the expiration of the start-up period set in step 54. The value set for the threshold current value in step 64 is the initial threshold current value. During the initial operation of the conveyor, the initial threshold current value set in step 64 will be the value shortly after the initial movement of the carriage. In one example, if the carriage is on the ground floor and is moving upward to the first floor with a load, the initial threshold current value will be the maximum current that should be drawn by the drive motor of the vertical reciprocating conveyor 10, since the largest amount of the lifting chain 24 is being lifted along with the weight supported by the carriage 12. Alternatively, if the carriage 12 is at the highest floor location when the conveyor begins to operate, the combined weight of the carriage and chain will increase as the length of the chain increases.

Once the threshold current value has been set in step 64, the system proceeds to step 66 during which the control unit determines the present amount of current being drawn by the drive motor. As described previously, the control unit 34 determines the present amount of current draw on a real-time basis through the use of the current sensor 36.

In one embodiment of the disclosure, the system receives multiple current measurements each second. In step 66, the control unit of the present disclosure determines a present current value by taking an average of multiple current measurements taken over a measurement period. As an illustrative example, the measurement period could be a one second interval during which the control unit receives between five and twenty individual current readings. The control unit sums the multiple current readings taken during the one second measurement period and generates an average value which the control unit then utilizes as the present current value. Although a one second measurement period is contemplated in accordance with the present disclosure, the measurement period could be shorter or longer depending upon the specific type of current sensor and control unit. Calculating the average value of a series of current samples over relatively short measurement period has the effect of filtering out noise, which results in a more accurate present current value determination in step 66. However, it should be understood that instead of averaging multiple measurements over a measurement period, the system could take current measurements at a lower frequency and simply use a single current measurement as the present current value.

In step 67, the control unit determines whether the present current value is above a maximum overload current for the drive motor. The maximum overload current for the drive motor 28 is stored in the memory location 46 and is a set value for the particular motor and conveyor assembly, normally representing the full load current rating for the drive motor at motor rated horsepower. If the control unit determines in step 67 that the present, real-time current draw is above the maximum overload value, the control unit proceeds to step 60 and stops operation of the drive motor.

If the system determines in step 67 that the present current value is below the maximum amount for the motor, the system proceeds to step 68.

In step 68, the control unit compares the present current value determined in step 66 to the threshold current set in step 64. As defined above, the threshold current is set in the control unit based upon an actual current value measured following the initial start-up period for the conveyor assembly.

In step 68, the control unit determines whether the present current value is greater than or less than the threshold current value by more than an operating limit. Since the carriage 12 can move either upward or downward, the control unit determine in step 68 whether the present current value differs from the threshold current value by more than an operating limit in both an increased amount of current or a decreased amount of current drawn by the drive motor. As an illustrative example, if the moving carriage 12 is moving upward and contacts an obstruction, the amount of current drawn by the drive motor will increase rapidly, which is detected by the control unit by the present current value being greater than the threshold current value by more than an operating limit. Alternatively, if the carriage is being lowered and contacts an object positioned on the ground floor, the object positioned on the ground floor will support some or all of the weight of the carriage. When the weight of the carriage is supported by the object, the amount of current drawn by the drive motor will sharply decrease. Thus, in step 68, the control unit will determine that the present current value is less than the threshold current value by more than the operating limit. In each case, if the present current value is greater than or less than the threshold current value by more than the operating limit, the system will proceed to step 60 and stop operation of the drive motor.

In one embodiment of the disclosure, the operating limit is determined by the control unit as a percentage of the threshold current set in step 64. In one embodiment, the operating limit is a percentage of between 1%-3% of the threshold current set in step 64. As an illustrative example, if the threshold current in step 64 is 100 amps and the operating limit is set to be 2%, the system will stop operation of the drive motor when the present current value exceeds 102 amps or falls below 98 amps. The percentage value used to set the operating limit can be set by the user through the user interface 32 and stored in the memory unit 46. The user can adjust the percentage through the user interface if the present selected value is either too sensitive or not sensitive enough for the particular application.

If the present current value does not exceed or fall below the threshold current value by the operating limit as determined in step 68, the system proceeds to step 70 and increments a threshold counter in step 70. The threshold counter 70 is used by the control unit to determine when the threshold current value should be updated. In one embodiment of the disclosure, the threshold current value is updated once every five seconds, although other periods could be utilized while operating within the scope of the present disclosure. The threshold counter incremented in step 70 allows the system to make a number of comparisons of the present current value to the threshold current value prior to updating the threshold current value. In the embodiment described, the present current value is compared to the threshold current value once every second and if the threshold current value is updated once every five seconds, the counter in step 70 will count to five to insure that the threshold current is updated once every five seconds.

If the control unit determines in step 72 that the counter has not reached the preset value, the system returns to step 66 and once again determines the present current value. This process continues until the control unit determines in step 72 that the counter has reached the preset count value. Once the counter reaches the preset count value, the control unit proceeds to step 74 during which the threshold current value is set to be the present current value determined in step 66. In this manner, the threshold current value is updated to the present current value at a regular interval. In the embodiment shown in FIG. 3, the threshold current value is updated after a predetermined number of measurement periods have passed. As described, in one embodiment of the disclosure, five measurement periods pass before the threshold current value is set to be the present current value.

As illustrated in step 76, the threshold counter is reset and the control unit returns back to step 66, during which the control unit again determines the present current value being drawn by the drive motor. The steps continue as long as the present current value does not exceed or fall below the threshold current value by more than the preset operating limit. As can be understood by the above description, the control unit continuously monitors the amount of current drawn by the drive motor and compares the real-time current draw by the drive motor to a threshold value. The threshold current value is updated on a periodic basis and thus compensates for the increased weight of the carriage due to the increased or decreased weight of the driving chain. Unlike past systems that set a fixed current limit after the initial operating phase of the conveyor, the system and method of the present disclosure continuously updates the threshold current value and compares the present current value to the updated threshold current value to compensate for change in the weight of the carriage and driving chain being lifted by the drive motor.

Although the present disclosure is described as being particularly desirable for use with a vertical reciprocating conveyor that utilizes an electric drive motor to lift a carriage, the method and system of the present disclosure could also be utilized with other types of drive mechanisms, such as a hydraulically powered vertical reciprocating conveyor (VRC). In such an embodiment, a pressure transducer is used in place of the current sensor shown in FIG. 2 and the control unit 34 monitors the pressure of the hydraulic fluid needed to raise and lower the carriage. FIG. 4 illustrates an embodiment of the disclosure for use with a hydraulically powered VRC.

In the embodiment shown in FIG. 4, the contactor 38 is positioned between the power supply 42 and a hydraulic pump 70. The hydraulic pump 70 is electrically operated such that when the single switch 40 moves to the closed position, the contactor 38 enables the operation of the hydraulic pump 70. As in the previous embodiment, the contactor 38 is coupled to the control unit 34 such that the control unit can interrupt operation of the hydraulic pump 70 by opening the switch 40 of the contactor 38 through control line 44.

The hydraulic pump 70 provides a source of pressurized hydraulic fluid to a pair of hydraulic lifting cylinders 72 through a supply line 74. The hydraulic fluid contained within the pressure supply line 74 must be sufficient for the hydraulic lifting cylinders 72 to elevate the carriage 12. Likewise, when the carriage 12 is lowered, the pressure of hydraulic fluid within the supply line 74 must be sufficient to support the weight of the carriage and any supported objects being moved by the carriage.

In the embodiment shown in FIG. 4, a pressure sensor 76 is in communication with the hydraulic fluid supply line 74 through a sensing conduit 78. The pressure sensor 76 is able to sense the pressure of hydraulic fluid in the supply line 74 and relay the sensed pressure to the control unit 34. The pressure sensor 76 can be any type of pressure sensor that is able to provide an accurate, real-time pressure measurement to the control unit 34. The pressure sensor 76 monitors the pressure of fluid within the supply line 74 in real-time such that the control unit 34 monitors the pressure of the hydraulic fluid provided by the hydraulic pump 70 and can discontinue operation of the hydraulic pump 70 upon an over-pressure or an under-pressure condition that may be a result of an obstruction to the movable carriage 12.

The control unit 34 operates in a similar manner as shown and described in FIG. 3 with respect to the embodiment that senses the current drawn by a drive motor. However, instead of comparing sensed current values to threshold current values, the control unit 34 compares sensed pressure values to threshold pressure value.

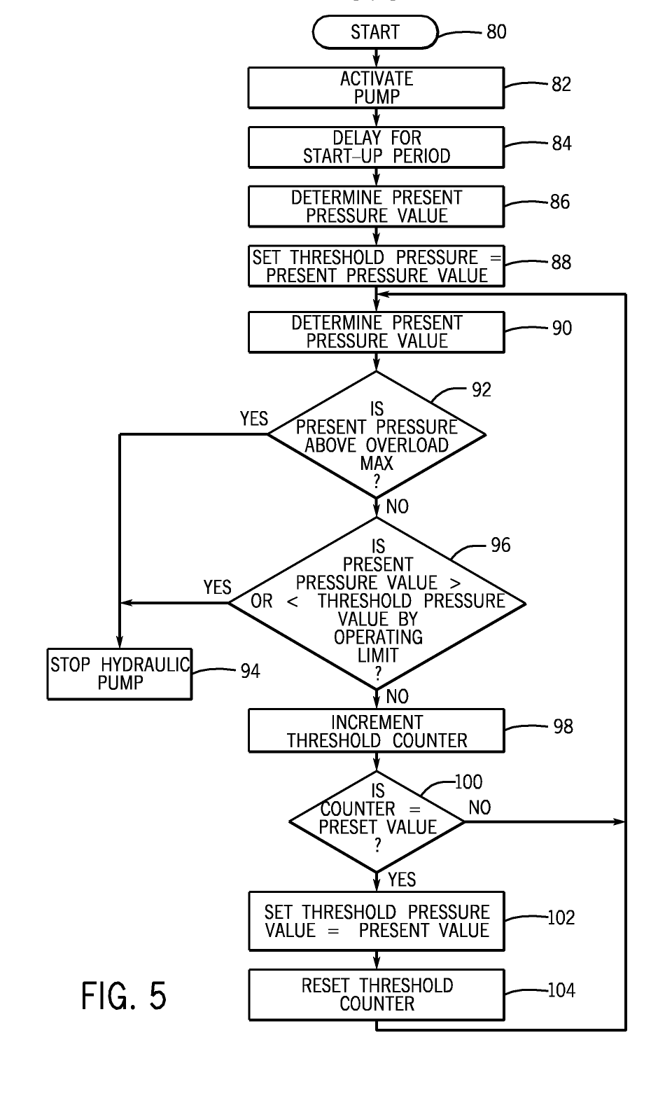

FIG. 5 includes a flowchart that further illustrates the overload detection process of the present disclosure when utilized with a hydraulically powered VRC.

In the method shown in FIGS. 4 and 5, the control unit initially receives an input from the user interface that a request to start the hydraulic pump has been received, as indicated by step 80. In response to receiving the request to start operation of the hydraulic pump, the control unit closes the switch 40 in the contactor 38. When the switch 40 is closed, power is supplied to the hydraulic pump as indicated in step 82.

Once the hydraulic pump has been activated, the control unit delays for a start-up period in step 84. The start-up period allows the hydraulic pump to begin operation before the control unit begins to monitor the pressure of the hydraulic fluid from the pump.

In step 86, the control unit obtains a signal from the pressure sensor 76 to determine the present pressure value of the hydraulic fluid being supplied to the hydraulic lifting cylinders. In step 88, the control unit sets a threshold pressure value to be the present pressure value of the hydraulic fluid being supplied to the hydraulic lifting cylinders following the expiration of the start-up period set in step 84. The value set for the threshold pressure value in step 88 is the pressure value shortly after the initial movement of the carriage.

Once the threshold pressure value has been set in step 88, the system proceeds to step 90 during which the control unit determines the present pressure of the hydraulic fluid being supplied from the hydraulic pump to the lifting cylinders. As described previously, the control unit determines the present pressure on a real-time basis through use of the pressure sensor 76.

As with the current sensor, the control unit can receive multiple pressure measurements each second and can determine the present pressure value based upon various different combinations of the pressure measurements, as was the case with the current sensor previously described.

In step 92, the control unit determine whether the present pressure value is above a maximum overload pressure for the hydraulic pump. The maximum overload pressure for the pump is stored in the memory location 46 and is a set value for the particular pump and conveyor assembly, normally representing the maximum pressure the pump can provide. If the control unit determines in step 92 that the present, real-time pressure of the hydraulic fluid is above the maximum overload value, the control unit proceeds to step 94 and stops operation of the hydraulic pump.

If the system determines in step 92 that the present pressure value is below the overload maximum, the system proceed to step 96.

In step 96, the control unit determines whether the present pressure value is greater than or less than the threshold pressure value by more than an operating limit. Since the carriage can move either upward or downward, the control unit determines in step 96 whether the present pressure value differs from the threshold pressure value by more than an operating limit in both an increased amount of pressure or a decreased amount of pressure for the hydraulic fluid supplied by the hydraulic pump. As an illustrative example, if the moving carriage is moving upward and contacts an obstruction, the pressure of the fluid being supplied by the hydraulic pump will increase rapidly, which is detected by the control unit by the present pressure value being greater than the threshold pressure value by more than an operating limit. Alternatively, if the carriage is being lowered and contacts an object positioned on the ground floor, the object positioned on the ground floor will support some or all of the weight of the carriage. When the weight of the carriage is supported by the object, the pressure of the hydraulic fluid supplied by the hydraulic pump will sharply decrease. Thus, in step 96, the control unit determines whether the present pressure value is less than the threshold pressure value by more than the operating limit. In each case, if the present pressure value is greater than or less than the threshold pressure value by more than the operating limit, the system will proceed to step 94 and stop operation of the hydraulic pump.

In one embodiment of the disclosure, the operating limit is determined by the control unit as a percentage of the threshold pressure set in step 88. The percentage can be set by the user or can be preprogrammed into the memory unit 46. If the present pressure value does not exceed or fall below the threshold pressure value by the operating limit as determined in step 96, the system proceeds to step 98 and increments a threshold counter. The threshold counter is used by the control unit to determine when the threshold pressure value should be updated. In one embodiment of the disclosure, the threshold pressure value is updated once every five seconds, although other periods could be utilized while operating within the scope of the present disclosure. The threshold counter incremented in step 98 allows the system to make a number of comparisons of the present pressure value to the threshold pressure value prior to updating the threshold pressure value.

If the control unit determines in step 100 that the counter has not reached the preset value, the system returns to step 90 and once again determines the pressure value. This process continues until the control unit determine in step 100 that the counter has reached the preset count value. Once the counter reaches the preset count value, the control unit proceeds to step 102 during which the threshold pressure value is set to be the present pressure value determined in step 90.

As illustrated in step 104, the threshold counter is reset and the control unit returns back to step 90, during which the control unit again determines the present pressure value of the hydraulic fluid being supplied by the hydraulic pump. These steps continue as long as the present pressure value does not exceed or fall below the threshold pressure value by more than the preset operating limit.

As can be understood by the comparison between the pressure monitoring method and the current monitoring method, the control unit carries out similar functions based upon the monitored system value, regardless of whether the monitored system value is a pressure value or a current value. In each case, the system and method of the present disclosure updates a threshold value on a periodic basis and compares the current monitored value to the threshold value.

I claim:

1. A method of controlling the operation of a vertical reciprocating conveyor having a drive motor to move a carriage, comprising the steps of:
operating the drive motor to initially move the carriage from a resting location;
sensing the amount of current drawn by the motor to initially move the carriage from the resting location;
defining a threshold current value based upon the sensed amount of current drawn by the drive motor during the initial movement of the carriage;
comparing a present value of current drawn by the drive motor to the threshold current value and stopping the drive motor when the present current value varies from the threshold current value by more than an operating limit;
updating the threshold current value to be the present current value when the present current value is within the operating limit; and
continuously repeating the steps of comparing and updating as long as the present current value is within the operating limit.

2. The method of claim 1 wherein the operating limit is defined as an amount of current both below and above the threshold current value.

3. The method of claim 2 wherein the amount of change is a predetermined percentage of the threshold current value.

4. The method of claim 1 wherein the present value of current is an average of multiple current measurements taken over a measurement period.

5. The method of claim 4 wherein the threshold current is updated after a predetermined number of measurement periods.

6. The method of claim 4 wherein the multiple current measurements are the most recent current measurements.

7. The method of claim 1 wherein the threshold current is defined after an initial operating period.

8. The method of claim 5 wherein the threshold current is set as the most recent current measurement.

9. A method of controlling the operation of a vertical reciprocating conveyor having a drive mechanism to lift a carriage, comprising the steps of:
operating the drive mechanism to move the carriage in either an upward direction or a downward direction;
continuously sensing a sensed value created by the drive mechanism in moving the carriage;
continuously comparing the present sensed value to a threshold sensed value during movement of the carriage in either the upward or downward direction;
stopping the drive source when the present sensed value varies from the threshold sensed value by more than an operating limit; and
updating the threshold sensed value to be the present sensed value when the present sensed current value is within the operating limit.

10. The method of claim 9 wherein the operating limit is defined as an amount of change both below and above the threshold sensed value.

11. The method of claim 10 wherein the amount of change is a predetermined percentage of the threshold sensed value.

12. The method of claim 9 wherein the threshold sensed value is updated on a predetermined periodic basis.

13. The method of claim 12 wherein the threshold sensed value is updated to be the most recent sensed value at the end of the predetermined periodic basis.

14. The method of claim 9 wherein the sensed value is current and the drive mechanism is a drive motor.

15. The method of claim 9 wherein the sensed value is pressure and the drive mechanism is a hydraulic pump.

16. A control system for a vertical reciprocating conveyor having a drive motor for lifting a movable carriage, the system comprising:
a sensing module configured to sense the amount of current drawn by the drive motor during movement of the carriage in either an upward or downward direction; and
a controller configured to continuously sense the amount of current drawn by the drive motor and compare the sensed current to a threshold current value, wherein the control unit stops operation of the drive motor when the sensed current value varies from the threshold current value by more than an operating limit and wherein the controller updates the threshold current value to the sensed current value when the sensed current value is within the operating limit.

17. The control system of claim 16 wherein the control unit updates the threshold current value on a periodic basis.

18. The control system of claim 16 wherein the sensed current value is determined as an average of multiple current value measurements.

19. A method of controlling the operation of a vertical reciprocating conveyor having a hydraulic pump to supply pressurized hydraulic fluid to hydraulic cylinders to move a carriage, comprising the steps of:
operating the hydraulic pump to initially move the carriage from a resting location;
sensing the pressure of the hydraulic fluid required to initially move the carriage from the resting location;
defining a threshold pressure value based upon the sensed pressure value of the hydraulic fluid during the initial movement of the carriage;
comparing a present value of pressure of the hydraulic fluid to the threshold pressure value and stopping the hydraulic pump when the present pressure value varies from the threshold pressure value by more than an operating limit;
updating the threshold pressure value to be the present pressure value when the present pressure value is within the operating limit; and
continuously repeating the steps of comparing and updating as long as the present pressure value is within the operating limit.

20. The method of claim 19 wherein the operating limit is defined as an amount of pressure both below and above the threshold pressure value.

21. The method of claim 19 wherein the threshold pressure value is updated after a predetermined number of measurement periods.
